(19) United States
(12) Patent Application Publication
(10) Pub. No.: US 2026/0025222 A1
(43) Pub. Date: Jan. 22, 2026

(54) ONSTAR JAMMING DETECTION USING INTERNAL VEHICLE CELLULAR RECEIVED STRENGTH SIGNAL INDICATOR BASIS

(71) Applicant: GM Global Technology Operations LLC, Detroit, MI (US)

(72) Inventors: Alex Jose Veloso, Rochester Hills, MI (US); Scott Thomas Droste, West Bloomfield, MI (US); Jang Hwan Oh, Troy, MI (US)

(21) Appl. No.: 18/776,904

(22) Filed: Jul. 18, 2024

(51) Int. Cl. H04K 3/00

(52) U.S. Cl. CPC H04K 3/224; H04K 3/28; H04K 3/86; H04K 3/88

(57) ABSTRACT

A vehicle includes a system that performs a method for preventing a theft of the vehicle. The system includes a communication device and a processor. The communication device is configured to receive an observed signal within a selected radio frequency band. The processor is configured to measure a strength of the observed signal, measure a quality of the observed signal, calculate a correlation coefficient between the strength of the observed signal and the quality of the observed signal, attempt to establish a heartbeat signal via a cellular network when the correlation coefficient meets a selected coefficient threshold, determine the observed signal to be a jamming signal when the heartbeat signal is not established, and control the vehicle to execute a preventative action for preventing the theft of the vehicle when the observed signal is determined to be the jamming signal.

The subject disclosure relates to vehicles and, in particular, to a method for operating an anti-theft system of the vehicle to counter the use of a jamming device.

A vehicle can have an anti-theft system that connects it to a back office that monitors it. The vehicle and the back office communicate a monitoring signal periodically. An intruder can attempt to jam this signal when stealing the vehicle. If the monitoring signal is lost, the vehicle may conclude that it is being stolen and take preventative actions. However, the monitoring signal can also be lost in other scenarios, such as when the vehicle enters a tunnel, is in the mountains or is in rural areas. These scenarios can result in a false positive detection for theft. Accordingly, it is desirable to provide a system and method for detecting an attempted theft of the vehicle without producing a false positive.

### SUMMARY

In one exemplary embodiment, a method of preventing a theft of a vehicle is disclosed. A strength of an observed signal received at the vehicle within a selected radio frequency band is measured. A quality of the observed signal within the selected radio frequency band is measured. A correlation coefficient is calculated between the strength of the observed signal and the quality of the observed signal. An attempt is made to establish a heartbeat signal via a cellular network when the correlation coefficient meets a selected coefficient threshold. The observed signal is determined to be a jamming signal when the heartbeat signal is not established. The vehicle is controlled to execute a preventative action for preventing the theft of the vehicle when the observed signal is determined to be the jamming signal.

In addition to one or more of the features described herein, the method further includes calculating the correlation coefficient when the strength of the observed signal is greater than a strength threshold and the quality of the observed signal is less than a quality threshold.

In addition to one or more of the features described herein, the method further includes determining the observed signal to be the jamming signal when the correlation coefficient is positive.

In addition to one or more of the features described herein, the method further includes attempting to establish a heartbeat signal with a remote location when the correlation coefficient is positive and performing the preventative action when the vehicle is unable to establish the heartbeat signal with the remote location.

In addition to one or more of the features described herein, the correlation coefficient is a Pearson Correlation Coefficient.

In addition to one or more of the features described herein, the method further includes determining the correlation coefficient using strength values and quality values within a moving window.

In addition to one or more of the features described herein, the preventative action is at least one of turning off an engine of the vehicle, inhibiting ignition of the engine, commencing a video recording device at the vehicle, commencing an audio recording device at the vehicle, generating an alarm at the vehicle, and placing an upper limit on a speed of the vehicle.

In another exemplary embodiment, a system for preventing a theft of a vehicle is disclosed. The system includes a communication device and a processor. The communication device is configured to receive an observed signal within a selected radio frequency band. The processor is configured to measure a strength of the observed signal, measure a quality of the observed signal, calculate a correlation coefficient between the strength of the observed signal and the quality of the observed signal, attempt to establish a heartbeat signal via a cellular network when the correlation coefficient meets a selected coefficient threshold, determine the observed signal to be a jamming signal when the heartbeat signal is not established, and control the vehicle to execute a preventative action for preventing the theft of the vehicle when the observed signal is determined to be the jamming signal.

In addition to one or more of the features described herein, the processor is further configured to calculate the correlation coefficient when the strength of the observed signal is greater than a strength threshold and the quality of the observed signal is less than a quality threshold.

In addition to one or more of the features described herein, the processor is further configured to determine the observed signal to be the jamming signal when the correlation coefficient is positive.

In addition to one or more of the features described herein, the processor is further configured to attempt to establish a heartbeat signal with a remote location when the correlation coefficient is positive and perform the preventative action when the vehicle is unable to establish the heartbeat signal with the remote location.

In addition to one or more of the features described herein, the correlation coefficient is a Pearson Correlation Coefficient.

In addition to one or more of the features described herein, the processor is further configured to determine the correlation coefficient using strength values and quality values within a moving window.

In addition to one or more of the features described herein, the preventative action is at least one of turning off an engine of the vehicle, inhibiting ignition of the engine, commencing a video recording device at the vehicle, commencing an audio recording device at the vehicle, generating an alarm at the vehicle, and placing an upper limit on a speed of the vehicle.

In yet another exemplary embodiment, a vehicle is disclosed. The vehicle includes a communication device, an actuator device, and a processor. The communication device is configured to receive an observed signal within a selected radio frequency band. The actuator device is configured to prevent a theft of the vehicle. The processor is configured to measure a strength of the observed signal, measure a quality of the observed signal, calculate a correlation coefficient between the strength of the observed signal and the quality of the observed signal when the strength of the observed signal is greater than a strength threshold and the quality of the observed signal is less than a quality threshold, attempt to establish a heartbeat signal via a cellular network when the correlation coefficient meets a selected coefficient threshold, determine the observed signal to be a jamming signal when the heartbeat signal is not established, and control the actuator device to execute a preventative action for preventing the theft of the vehicle when the observed signal is determined to be the jamming signal.

In addition to one or more of the features described herein, the processor is further configured to determine the observed signal to be the jamming signal when the correlation coefficient is positive.

In addition to one or more of the features described herein, the processor is further configured to attempt to establish a heartbeat signal with a remote location when the correlation coefficient is positive and perform the preventative action when the vehicle is unable to establish the heartbeat signal with the remote location.

In addition to one or more of the features described herein, the correlation coefficient is a Pearson Correlation Coefficient.

In addition to one or more of the features described herein, the processor is further configured to determine the correlation coefficient using strength values and quality values within a moving window.

In addition to one or more of the features described herein, the preventative action is at least one of turning off an engine of the vehicle, inhibiting ignition of the engine, commencing a video recording device at the vehicle, commencing an audio recording device at the vehicle, generating an alarm at the vehicle, and placing an upper limit on a speed of the vehicle.

The above features and advantages, and other features and advantages of the disclosure are readily apparent from the following detailed description when taken in connection with the accompanying drawings.

### BRIEF DESCRIPTION OF THE DRAWINGS

Other features, advantages and details appear, by way of example only, in the following detailed description, the detailed description referring to the drawings in which:

FIG. 1 is a diagram of an anti-theft system for a vehicle, in accordance with an exemplary embodiment;

FIG. 2 shows a block diagram of various operations that can be performed by the processor of the controller;

FIG. 3 is a graph showing signal parameters that can be measured to detect the presence of a jamming signal;

FIG. 4 is a table of Received Signal Strength Indicator (RSSI) values and Reference Signal Received Quality (RSRQ) values for an observed signal obtained during a normal communications of the vehicle;

FIG. 5 is a table of RSSI values and RSRQ values for an observed signal obtained when the vehicle is being jammed; and

FIG. 6 is a flowchart illustrating a method of detecting and responding to a jamming signal, in an embodiment.

### DETAILED DESCRIPTION

The following description is merely exemplary in nature and is not intended to limit the present disclosure, its application or uses. It should be understood that throughout the drawings, corresponding reference numerals indicate like or corresponding parts and features. As used herein, the term module refers to processing circuitry that may include an application specific integrated circuit (ASIC), an electronic circuit, a processor (shared, dedicated, or group) and memory that executes one or more software or firmware programs, a combinational logic circuit, and/or other suitable components that provide the described functionality.

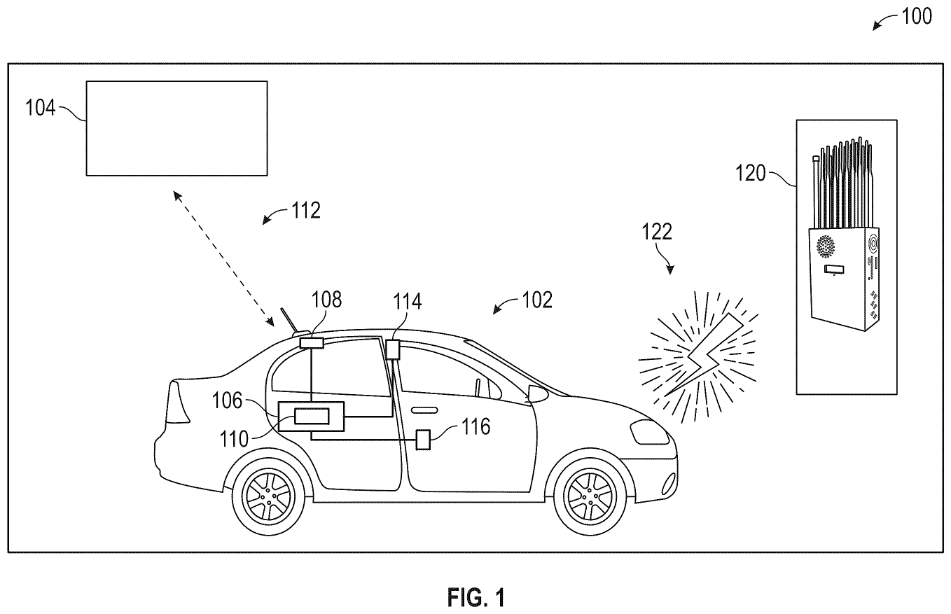

In accordance with an exemplary embodiment, FIG. 1 is a diagram of an anti-theft system 100 for a vehicle. The anti-theft system 100 includes the vehicle 102 and a back office 104 or remote location. The vehicle 102 includes a controller 106 and a communication device 108 including a transmitter and a receiver. An anti-theft monitoring signal, also referred to herein as a heartbeat signal 112, is communicated between the back office 104 and the controller 106 on a periodic basis. During normal operation, a heartbeat signal 112 includes the vehicle 102 transmitting a signal to the back office 104 and the back office 104 returning a response signal to the vehicle. The heartbeat signal 112 can be an encrypted signal and is transmitted with a given strength over a selected frequency band. When the back office 104 becomes aware that the vehicle 102 has been stolen, the back office 104 can send an anti-theft message to the vehicle to cause the vehicle to take a preventative action to thwart the theft.

The vehicle 102 further includes a recording device 114 or camera that can record images of either an exterior of the vehicle or an interior of the vehicle. The recording device 114 can, alternatively or in addition, be an audio recording device. The vehicle 102 further includes various actuation devices 116 that can be deployed to prevent a theft of the vehicle, using the methods disclosed herein.

A thief can attempt theft using a jamming device 120 to interrupt the heartbeat signal at the vehicle 102. The jamming device 120 transmits a jamming signal 122 that interferes with the communication (including the heartbeat signal 112) between the back office 104 and the vehicle 102, thereby preventing the back office from recognizing a theft.

The controller 106 may include processing circuitry (processor 110) that may include an application specific integrated circuit (ASIC), an electronic circuit, a processor (shared, dedicated, or group) and memory that executes one or more software or firmware programs, a combinational logic circuit, and/or other suitable components that provide the described functionality. The controller 106 may include a non-transitory computer-readable medium that stores instructions which, when processed by one or more processors of the controller 106, implement a method of detecting the jamming signal 122 and controlling various anti-theft operations at the vehicle in response to this detection, according to one or more embodiments detailed herein.

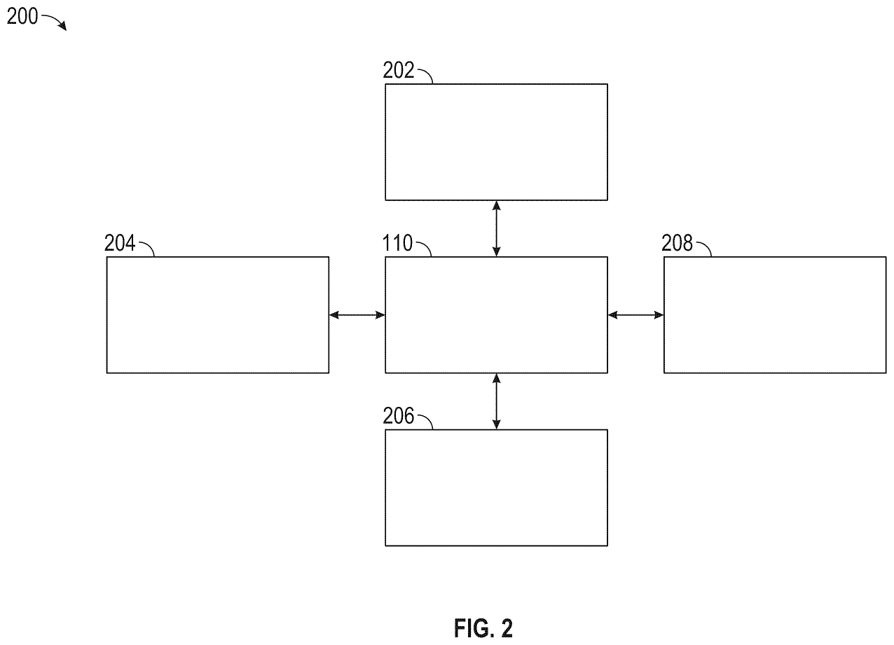

FIG. 2 shows a block diagram 200 of various operations that can be performed by the processor 110 of the controller 106. The processor 110 can operate various modules, including a telematics or communications module 202, a column lock module 204, a body control module 206, and other modules 208.

The communications module 202 controls sending and receiving of signals between the vehicle 102 and the back office 104. The signals can be sent using various communication systems including, but not limited to, Blue Tooth (BT), Bluetooth low energy (BLE), Wi-Fi, Cellular, and Vehicle to Everything (V2X). The column lock module 204 can perform or execute a steering column lock that prevents the steering column from being rotated or at least hinders the rotational ability of the steering column. The body control module 206 controls various operations that can prevent vehicle theft, such as preventing the vehicle engine from being started (or turning off the vehicle engine, if the vehicle engine is on). The other modules 208 can perform or execute additional functions such as sounding an alarm, limiting a maximum speed of the vehicle, activating a recording device, which can be a video recording device that records a video and/or an audio recording device which records audio, etc.

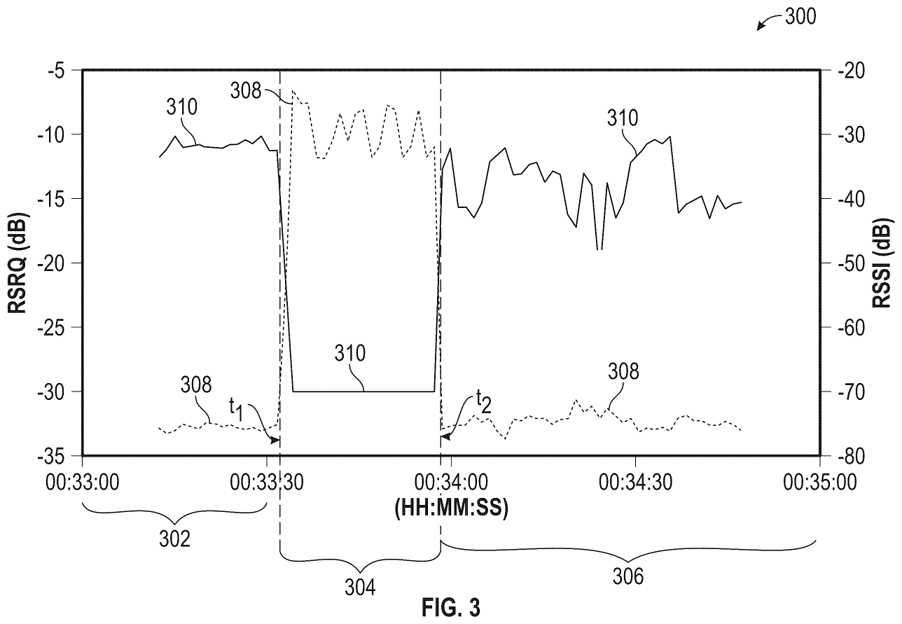

FIG. 3 is a graph 300 showing signal parameters that can be measured to detect the presence of a jamming signal. Time is shown along the abscissa. Signal strength is measured in units of Received Signal Strength Indicator (RSSI) and is shown along the right axis in decibels (dB). Signal quality is measured in units of Reference Signal Received Quality (RSRQ) and is shown along the left axis in decibels (dB). The time is split into a first time period 302, a second time period 304 and a third time period 306, for illustrative purposes. The first time period 302 occurs before a first time t₁. The second time period 304 occurs between the first time t₁ and a second time t₂. The third time period 306 occurs after the second time t₂.

The graph 300 shows a first curve 308 indicating the RSSI of an observed signal and a second curve 310 indicating the RSRQ of the observed signal. During the first time period 302 and the third time period 306, normal communication is occurring between the vehicle 102 and the back office 104. A jamming signal is turned on at first time t₁, remains on during the second time period 304, and is turned off at second time t₂. During normal communications (i.e., first time period 302 and third time period 306), the observed signal is a heartbeat signal having a relatively low RSSI (about −75 dB) and a relatively high RSRQ (about −10 dB). During jamming (i.e., the second time period 304), the observed signal is a jamming signal having a relatively high RSSI (about −30 dB) and a relatively low RSRQ (about −30 dB). A correlation coefficient can be calculated between the signal strength (RSSI) and signal quality (RSRQ) to determine whether the observed signal is a jamming signal or a normal heartbeat signal.

In an embodiment, the correlation coefficient is a Pearson Correlation Coefficient, as shown in Eq. (1):

$$r = \frac{\sum ( {x}_{i} - \overline{x} ) ( {y}_{i} - \overline{y} )}{\sqrt{\sum {( {x}_{i} - \overline{x} )}^{2} {( {y}_{i} - \overline{y} )}^{2}}} \qquad Eq . ( 1 )$$

where r is the correlation coefficient, xᵢ is an i^{th} measured value of the RSSI, x̅ is a mean of the values of the xᵢ, yᵢ is an i^{th} measured value of the RSRQ, y̅ is a mean of the values of the yᵢ. During normal communications, the correlation coefficient is negative. During a jamming operation, the correlation coefficient is positive.

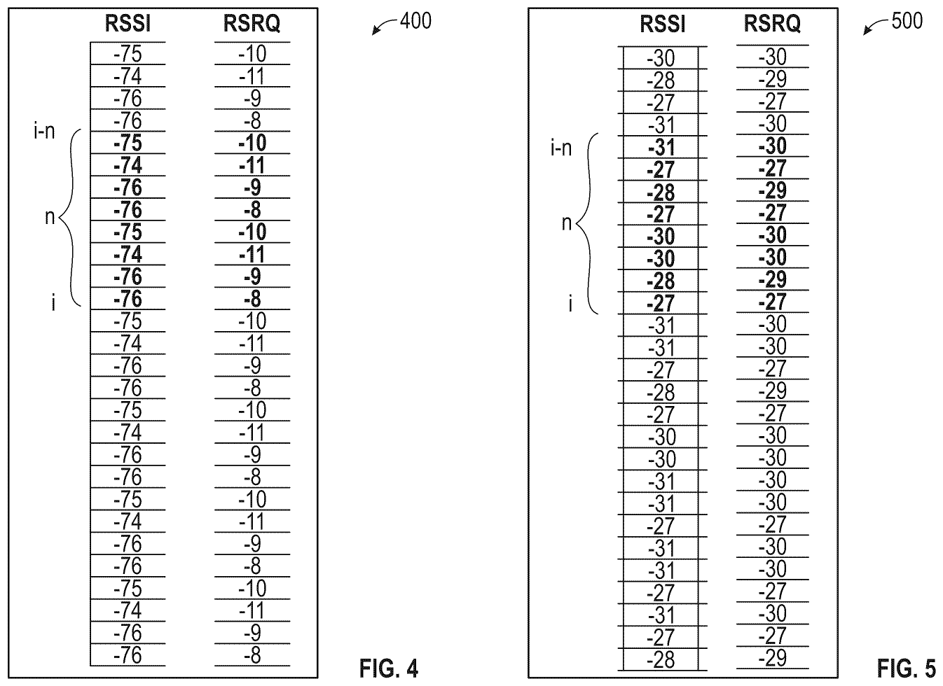

FIG. 4 is a table 400 of RSSI values and RSRQ values for an observed signal obtained during a normal communications of the vehicle. A first column includes RSSI values and a second column includes RSRQ. RSSI values and RSRQ values in the same row are obtained simultaneously. Time increases as you move down the column. For illustrative purposes, a moving window of time length n is placed extending backward from an i^{th} time. The RSSI values and RSRQ values within the moving window (i.e., from i-n to i) are used to calculate the correlation coefficient for the i^{th} time, such as by using Eq. (1). For the illustrative RSSI values and RSRQ values shown, the correlation coefficient is a negative value (e.g., r=−0.943879807).

FIG. 5 is a table 500 of RSSI values and RSRQ values for an observed signal obtained when the vehicle is being jammed. The moving window is shown. For RSSI values and RSRQ values during jamming, the correlation coefficient is a positive value (e.g., r=0.926736047).

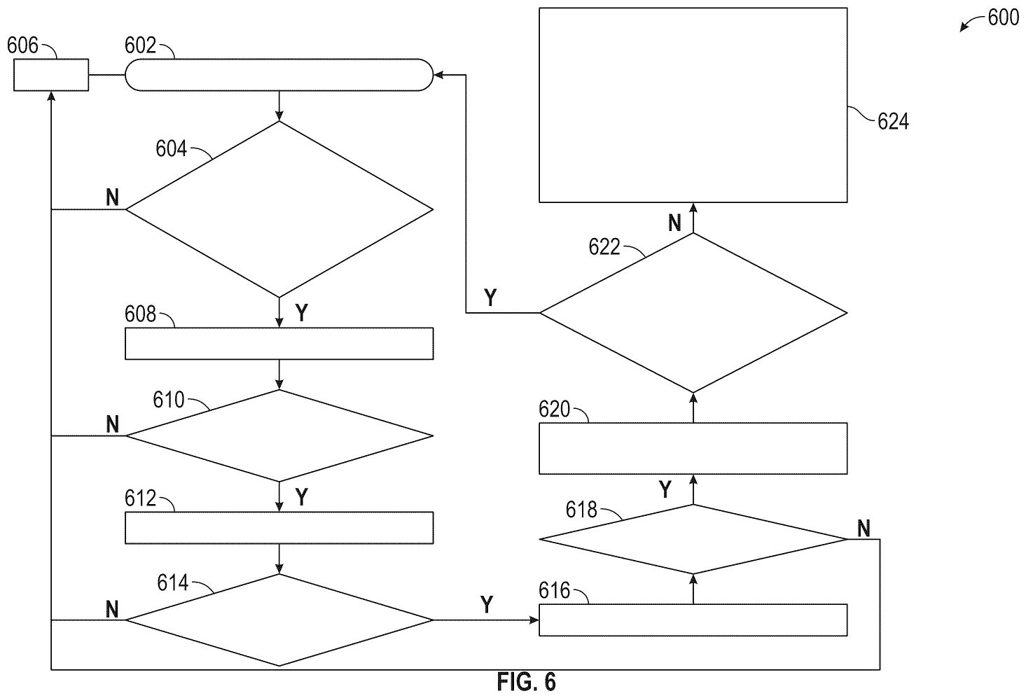

FIG. 6 is a flowchart 600 illustrating a method of detecting and responding to a jamming signal, in an embodiment. The method begins at box 602 with the ignition of the vehicle turned on. In box 604, a health check is performed on the communication systems (i.e., antenna, communication module, etc.) of the vehicle. If the communication systems do not pass the health check, the method proceeds to box 606. In box 606, the method proceeds to wait for a selected amount (e.g., 10 seconds), after which the method returns to box 602.

Returning to box 604, if the communication systems pass the health check, the method proceeds to box 608. In box 608, an observed signal is received over a selected radio frequency band and the RSSI of the observed signal is measured. In box 610, the RSSI is compared to an RSSI threshold (i.e., strength threshold). If the RSSI is less than the RSSI threshold (i.e., normal heartbeat signal), the method returns to box 606. Otherwise, the method proceeds to box 612.

In box 612, the RSRQ of the observed signal is measured. In box 614, the RSRQ is compared to an RSRQ threshold (i.e., quality threshold). If the RSRQ is greater than the RSRQ threshold (i.e., normal heartbeat signal), the method returns to box 606. Otherwise, the method proceeds to box 616.

In box 616, the correlation coefficient is calculated. In box 618, the sign of the correlation coefficient is observed. In other words, the correlation coefficient is compared to a correlation threshold that is equal to zero. If the sign is negative, the method returns to box 606. Otherwise, the method proceeds to box 620.

In box 620, the processor 110 attempts to establish a heartbeat signal with the back office using a cellular communication channel via the telematics or communications module 202 over a cellular network. In box 622, the success of the attempt is monitored. The processor 110 transmits an encrypted message and waits for a response. If the response is received, the heartbeat signal is healthy. If no response is received within a specified period of time, the heartbeat signal is not healthy. If the processor 110 is able to establish a healthy heartbeat signal with the back office, it can conclude that there is no jamming signal and thus there is no attempted theft. The method can then return to box 602. On the other hand, if the processor 110 is unable to establish a healthy heartbeat signal with the back office, it can conclude that a jamming signal is present. The method can then proceed to box 624. In box 624, preventative action(s) can be taken, performed or executed to prevent or hinder the theft of the vehicle. Exemplary preventative actions can include, but are not limited to, activating or sounding an alarm, inhibiting or preventing the vehicle engine from being started, turning off the vehicle engine if it is already on, placing an upper limit on a speed of the vehicle, activating a camera and/or recording device.

The terms “a” and “an” do not denote a limitation of quantity, but rather denote the presence of at least one of the referenced item. The term “or” means “and/or” unless clearly indicated otherwise by context. Reference throughout the specification to “an aspect”, means that a particular element (e.g., feature, structure, step, or characteristic) described in connection with the aspect is included in at least one aspect described herein, and may or may not be present in other aspects. In addition, it is to be understood that the described elements may be combined in any suitable manner in the various aspects.

When an element such as a layer, film, region, or substrate is referred to as being “on” another element, it can be directly on the other element or intervening elements may also be present. In contrast, when an element is referred to as being “directly on” another element, there are no intervening elements present.

Unless specified to the contrary herein, all test standards are the most recent standard in effect as of the filing date of this application, or, if priority is claimed, the filing date of the earliest priority application in which the test standard appears.

Unless defined otherwise, technical and scientific terms used herein have the same meaning as is commonly understood by one of skill in the art to which this disclosure belongs.

While the above disclosure has been described with reference to exemplary embodiments, it will be understood by those skilled in the art that various changes may be made and equivalents may be substituted for elements thereof without departing from its scope. In addition, many modifications may be made to adapt a particular situation or material to the teachings of the disclosure without departing from the essential scope thereof. Therefore, it is intended that the present disclosure not be limited to the particular embodiments disclosed, but will include all embodiments falling within the scope thereof.

What is claimed is:

1. A method of preventing a theft of a vehicle, comprising:
measuring a strength of an observed signal received at the vehicle, the observed signal being within a selected radio frequency band;
measuring a quality of the observed signal within the selected radio frequency band;
calculating a correlation coefficient between the strength of the observed signal and the quality of the observed signal;
attempting to establish a heartbeat signal via a cellular network when the correlation coefficient meets a selected coefficient threshold;
determining the observed signal to be a jamming signal when the heartbeat signal is not established; and
controlling the vehicle to execute a preventative action for preventing the theft of the vehicle when the observed signal is determined to be the jamming signal.

2. The method of claim 1, further comprising calculating the correlation coefficient when the strength of the observed signal is greater than a strength threshold and the quality of the observed signal is less than a quality threshold.

3. The method of claim 2, further comprising determining the observed signal to be the jamming signal when the correlation coefficient is positive.

4. The method of claim 3, further comprising attempting to establish a heartbeat signal with a remote location when the correlation coefficient is positive and performing the preventative action when the vehicle is unable to establish the heartbeat signal with the remote location.

5. The method of claim 1, wherein the correlation coefficient is a Pearson Correlation Coefficient.

6. The method of claim 5, further comprising determining the correlation coefficient using strength values and quality values within a moving window.

7. The method of claim 1, wherein the preventative action is at least one of: (i) turning off an engine of the vehicle; (ii) inhibiting ignition of the engine; (iii) commencing a video recording device at the vehicle; (iv) commencing an audio recording device at the vehicle; (v) generating an alarm at the vehicle; and (vi) placing an upper limit on a speed of the vehicle.

8. A system for preventing a theft of a vehicle, comprising:
a communication device configured to receive an observed signal within a selected radio frequency band;
a processor configured to:
measure a strength of the observed signal;
measure a quality of the observed signal;
calculate a correlation coefficient between the strength of the observed signal and the quality of the observed signal;
attempt to establish a heartbeat signal via a cellular network when the correlation coefficient meets a selected coefficient threshold;
determine the observed signal to be a jamming signal when the heartbeat signal is not established; and
control the vehicle to execute a preventative action for preventing the theft of the vehicle when the observed signal is determined to be the jamming signal.

9. The system of claim 8, wherein the processor is further configured to calculate the correlation coefficient when the strength of the observed signal is greater than a strength threshold and the quality of the observed signal is less than a quality threshold.

10. The system of claim 9, wherein the processor is further configured to determine the observed signal to be the jamming signal when the correlation coefficient is positive.

11. The system of claim 10, wherein the processor is further configured to attempt to establish a heartbeat signal with a remote location when the correlation coefficient is positive and perform the preventative action when the vehicle is unable to establish the heartbeat signal with the remote location.

12. The system of claim 8, wherein the correlation coefficient is a Pearson Correlation Coefficient.

13. The system of claim 12, wherein the processor is further configured to determine the correlation coefficient using strength values and quality values within a moving window.

14. The system of claim 8, wherein the preventative action is at least one of: (i) turning off an engine of the vehicle; (ii) inhibiting ignition of the engine; (iii) commencing a video recording device at the vehicle; (iv) commencing an audio recording device at the vehicle; (v) generating an alarm at the vehicle; and (vi) placing an upper limit on a speed of the vehicle.

15. A vehicle, comprising:
a communication device configured to receive an observed signal within a selected radio frequency band;
an actuator device for preventing a theft of the vehicle;
a processor configured to:
measure a strength of the observed signal;
measure a quality of the observed signal;
calculate a correlation coefficient between the strength of the observed signal and the quality of the observed signal when the strength of the observed signal is greater than a strength threshold and the quality of the observed signal is less than a quality threshold;
attempt to establish a heartbeat signal via a cellular network when the correlation coefficient meets a selected coefficient threshold;
determine the observed signal to be a jamming signal when the heartbeat signal is not established; and
control the actuator device to execute a preventative action for preventing the theft of the vehicle when the observed signal is determined to be the jamming signal.

16. The vehicle of claim 15, wherein the processor is further configured to determine the observed signal to be the jamming signal when the correlation coefficient is positive.

17. The vehicle of claim 16, wherein the processor is further configured to attempt to establish a heartbeat signal with a remote location when the correlation coefficient is positive and perform the preventative action when the vehicle is unable to establish the heartbeat signal with the remote location.

18. The vehicle of claim 15, wherein the correlation coefficient is a Pearson Correlation Coefficient.

19. The vehicle of claim 18, wherein the processor is further configured to determine the correlation coefficient using strength values and quality values within a moving window.

20. The vehicle of claim 15, wherein the preventative action is at least one of: (i) turning off an engine of the vehicle; (ii) inhibiting ignition of the engine; (iii) commencing a video recording device at the vehicle; (iv) commencing an audio recording device at the vehicle; (v) generating an alarm at the vehicle; and (vi) placing an upper limit on a speed of the vehicle.
